(19) United States
(12) Patent Application Publication
(10) Pub. No.: US 2008/0134511 A1
(43) Pub. Date: Jun. 12, 2008

(54) RAZOR WITH LED

(75) Inventor: William A. Salvatore, Watertown, CT (US)

Correspondence Address: MICHAUD-DUFFY GROUP LLP, 306 INDUSTRIAL PARK ROAD, SUITE 206, MIDDLETOWN, CT, 06457, US

(73) Assignee: EVEREADY BATTERY COMPANY, INC., St. Louis, MO (US)

(21) Appl. No.: 11/950,056

(22) Filed: Dec. 4, 2007

Related U.S. Application Data
(60) Provisional application No. 60/873,106, filed on Dec. 5, 2006.

(51) Int. Cl. B26B 21/46

(52) U.S. Cl. 30/32; 362/115

(57) ABSTRACT

According to the present invention a safety razor incorporates a light energy device adapted to provide a beneficial effect to the skin of the user of the safety razor during a normal shaving operation. The light energy emitted by the device has at least one wavelength in the range 200-1200 nm. The light energy device can be one or more LEDs that can be powered by a battery or domestic AC. According to a further embodiment of the present invention a light energy assembly is selectively attachable to the handle of a safety razor. The light energy assembly has a housing and a light energy device.

### CROSS REFERENCE TO RELATED APPLICATIONS

This application claims the benefit of U. S. Provisional Patent Application Ser. No. 60/873,106, filed Dec. 5, 2006.

### TECHNICAL FIELD

This invention relates generally to safety razors, and more specifically to safety razors that incorporate a light energy source that provides a beneficial effect to the skin of the user.

### BACKGROUND OF THE INVENTION

Many modem shaving implements, also commonly known as wet shave or safety razors, include a disposable razor cartridge releasably connected to a reusable handle and adapted to be selectively connected to the handle. The cartridge comprises a housing having at least one razor blade disposed therein. Other modem safety razors have a handle and a razor cartridge that are intended to be permanently coupled and disposed of as a single unit. A user generally desires a close shave where the cutting edge of the razor blade severs the user's hairs at a level close to the skin surface being shaved. A disadvantage of the wet shaving process is that the cutting edge can damage the outer layer of skin. This damage can be exacerbated by a user pressing the cartridge against the skin with excessive force or by inadequate pre-shave preparation.

The use of light energy to promote healing and skin treatment such as photo rejuvenation and so-called anti-aging is known. Several commercial devices including the WARP 10 marketed by WARP THERAPY; the DERMASTYLE SKIN REJUVENATOR marketed by LUMIPORT; the LED SKIN PHOTO REJUVENATION LIGHT marketed by LIGHT THERAPY PRODUCTS and devices marketed by OMNILUX utilize light emitting diodes (LEDs) of diverse wavelengths for different effects. Blue light in the approx 400-500 nanometer (nm) wavelength spectrum has been effective in treating acne and can be microbicidal. Visible and near infra-red red light in the approx 600-900 nm wavelength spectrum has proved helpful in wound care and the reduction of wrinkles and age spots. An important aspect of these light energy devices is that the power output is less than that of devices used for hair removal, U.S. Pat. No. 5,735,844 to Anderson et al being representative of many patents disclosing light energy devices for hair removal and hair growth inhibition. A disadvantage of the aforementioned commercial devices is their size. These generally include arrays of LEDs on large panels.

Based on the foregoing, it is desirous to provide a safety razor incorporating a light energy device that can provide a beneficial effect to the skin of the user.

### SUMMARY

An embodiment of the safety razor of the present invention includes a light energy device adapted to provide a beneficial effect to the skin of a user of the safety razor during a shaving operation. The light energy device can include at least one LED that can be powered by a battery or domestic AC. The safety razor can include a handle having a razor cartridge attached thereto. The razor cartridge comprises a guard and a cap. The LED can be disposed in the handle, the guard, the cap or combinations thereof. In a further embodiment a light energy assembly is selectively attachable to a handle of a safety razor. The light energy assembly includes a housing, a light energy device as previously described and means for attaching the assembly to the handle.

The above features and advantages of the present invention will be more fully understood with reference to the following detailed description when taken in conjunction with the accompanying drawings.

### BRIEF DESCRIPTION OF THE DRAWINGS

FIG. 1 is an isometric view of an embodiment of a safety razor of the present invention, partially cut away.

FIG. 2 is an isometric view of a further embodiment of a safety razor of the present invention.

### DETAILED DESCRIPTION

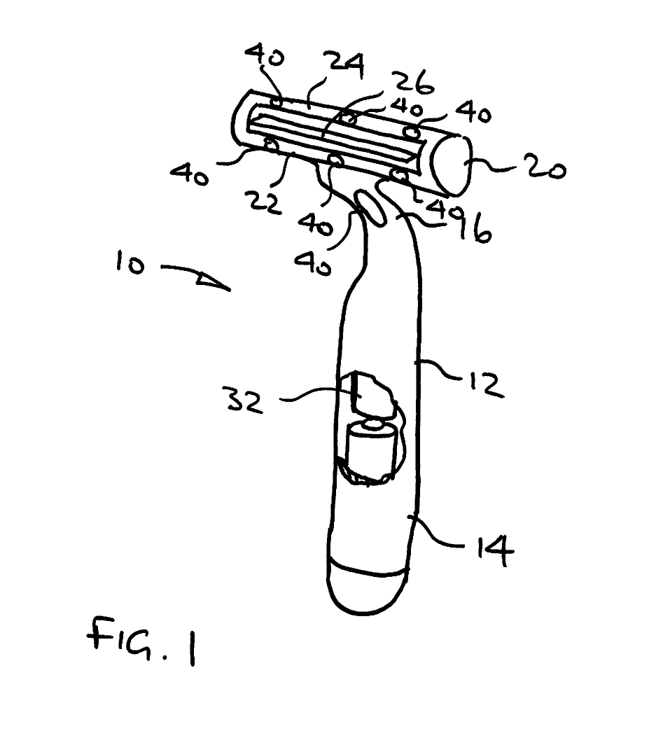

Referring to FIG. 1, an embodiment of the safety razor 10 comprises a handle 12 having a grip portion 14, a neck portion 16 and a cartridge connection portion. A razor cartridge 20 is coupled to the cartridge connection portion. The razor cartridge comprises a guard 22, a cap 24 and at least one razor blade 26, however razor cartridges having alternate construction can be utilized and the present invention is not limited in this regard. The grip portion has a cavity including a control circuit 32 for a light energy device, discussed later in the present application, disposed therein. The light energy device is preferably at least one light emitting diode (LED), 40. The LED can be powered by a battery that is preferably disposed in the cavity. The battery can be disposable or rechargeable. The LED can also be powered by domestic AC and the present invention is not limited in regard to the power source for the LED. The LED is preferable disposed in the handle facing in a direction toward the skin of a user when the safety razor is used in a customary manner for shaving and most preferably the LED is in the neck portion of the handle. The LED may also be disposed in the guard 22 or cap 24 of the razor cartridge. The light energy device can also comprise more than one LED that can be situated in at least one of the locations previously described and the present invention is not limited in regard to the number or placement of the LEDs. The light energy emitted by the LED has at least one wavelength in the range 300-1000 nm. At least one wavelength in the range 200-1200 nm has also been found to be beneficial. Each LED has a power consumption less than 200 mW, more preferably less than 100 mW, and an intensity less than 100 mcd, more preferably less than 50 mcd. An important aspect of the present invention is the intensity of each LED is significantly less than that of known (laser) LED devices used for e.g. hair removal or hair growth inhibition. The light energy emitted by the LED provides at least one of acne treatment; bactericidal effects; repair of photodamage; repair of non-melanoma skin cancers; treatment of diabetic skin ulcers; vitiligo; photo rejuvenation; anti-aging effects; reduction of scarring and wound healing, including healing wounds or other skin damage caused by shaving.

The control circuit includes a switch to initiate the operation of the LED. The control circuit may alternatively have an electronic component having a similar function to a switch, for example a sensor that provides an initiating signal in response to movement, ie when the razor is picked up, removed from a holding device (not shown) or in use, or in response to contact with water or the skin of the user. The present invention is not limited in regard to the initiation device.

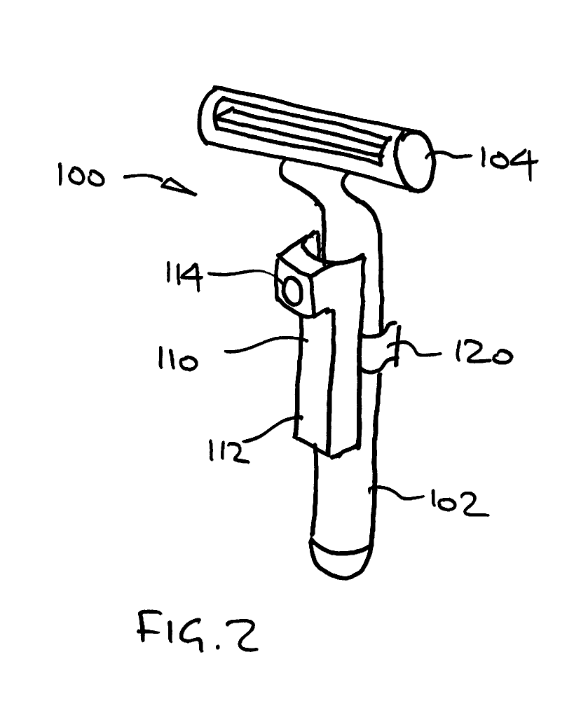

Referring now to FIG. 2, a further embodiment of the present invention is depicted including a safety razor 100 having a handle 102 and a razor cartridge 104. A light energy assembly 110 is attachable by the user to the handle. The light energy assembly is generally as previously described and includes a housing 112 having a control circuit and at least one LED 114 disposed therein. The LED (or LEDs) is positioned to face the skin of the user when the assembly is attached to the handle and in normal use. The assembly may be configured such that the LED precedes the cartridge (as depicted) during a normal shaving stroke, or follows the cartridge. The assembly can preferably include a battery. The means of attachment of the assembly to the handle is preferably by a snap-fitting clip arrangement 120 although other well known methods may be employed and the present invention is not limited in this regard. The light energy assembly provides beneficial effects as previously described.

It is to be understood that the present invention is by no means limited to the particular construction herein disclosed and/or shown in the drawings, but also comprises any modifications or equivalents within the scope of the disclosure.

What is claimed is:

1. A safety razor, including:
a handle, and
a light energy device adapted to provide a beneficial effect to the skin of a user of the safety razor during a shaving operation.

2. A safety razor according to claim 1, wherein the light energy device includes at least one LED.

3. A safety razor according to claim 1, wherein the light energy device emits light energy in at least one wavelength in the range 200-1200 nanometers.

4. A safety razor according to claim 3, wherein the light energy device emits light energy in at least one wavelength in the range 300-1000 nanometers.

5. A safety razor according to claim 2, wherein the at least one LED has a power consumption not more than 200 mW.

6. A safety razor according to claim 5, wherein the at least one LED has a power consumption not more than 100 mW.

7. A safety razor according to claim 2, wherein the at least one LED has an intensity less than 100 mcd.

8. A safety razor according to claim 7, wherein the at least one LED has an intensity less than 50 mcd.

9. A safety razor according to claim 2, further including a battery and the at least one LED is powered by the battery.

10. A safety razor according to claim 9, wherein the safety razor further includes a razor cartridge coupled to the handle, the razor cartridge including a guard and a cap, wherein the at least one LED is disposed in at least one of the handle, the guard and the cap, and wherein the battery is disposed in the handle.

11. A safety razor according to claim 1, wherein the beneficial effect includes at least one of: acne treatment; a bactericidal effect; repair of photodamage; repair of non-melanoma skin cancers; treatment of diabetic skin ulcers; vitiligo; photo rejuvenation; anti-aging effects; reduction of scarring and wound healing.

12. A light energy assembly in combination with a safety razor, the light energy assembly comprising:
a housing;
a light energy device adapted to provide a beneficial effect to the skin of a user of the safety razor during a shaving operation, and
attachment means for selectively attaching the light energy assembly to the safety razor.

13. A combination according to claim 12, wherein the beneficial effect includes at least one of: acne treatment; a bactericidal effect; repair of photodamage; repair of non-melanoma skin cancers; treatment of diabetic skin ulcers; vitiligo; photo rejuvenation; anti-aging effects; reduction of scarring and wound healing.

14. A combination according to claim 12, wherein the means for selectively attaching the light energy assembly to the safety razor includes a snap-fitting clip arrangement.
